(19) United States
(12) Patent Application Publication
(10) Pub. No.: US 2002/0078324 A1
(43) Pub. Date: Jun. 20, 2002

(54) Microprocessor and method of addressing in a microprocessor

(76) Inventors: Holger Sedlak, Egmating (DE); Oliver Kniffler, Munchen (DE)

Correspondence Address: LERNER AND GREENBERG, P.A., Post Office Box 2480, Hollywood, FL, 33022-2480, US

(21) Appl. No.: 09/928,011

(22) Filed: Aug. 10, 2001

Related U.S. Application Data
(63) Continuation of application No. PCT/DE00/00291, filed on Feb. 1, 2000.

(30) Foreign Application Priority Data
Feb. 10, 1999 (DE) 199 05 510.6

(51) Int. Cl. H04L 12/28; G06F 9/00

(52) U.S. Cl. 712/210; 712/228

(57) ABSTRACT

A microprocessor for processing various assembler codes, in which a parameter that designates the respective assembler code is provided in the microprocessor and, in dependence on how the parameter is set, a different relative addressing takes place. A method of relative addressing in the microprocessor is also disclosed in which, dependent on an operating state or parameter for the respective assembler code, relative addresses are differently determined.

### CROSS REFERENCE TO RELATED APPLICATION

This application is a continuation of copending International Application No. PCT/DE00/00291, filed Feb. 1, 2000, which designated the United States.

### BACKGROUND OF THE INVENTION

1. Field of the Invention

The present invention relates to a microprocessor for processing various assembler codes and a method of relative addressing in a microprocessor.

To allow them to be processed by a microprocessor, computer programs must be translated into what is known as an assembler code, i.e. into a programming language that can be directly executed by the microprocessor. There are currently various customary assembler codes on the market, for example JAVA byte code or ECO 2000 Assembler.

Prior-art microprocessors have until now always been constructed in such a way that they can only process a single assembler code. This is disadvantageous of course, since the computer programs then have to be translated for each processor into the assembler code respectively to be applied.

Published, European Patent Application EP 0 747 808 A discloses a processor in which different sets of instructions can be used. Switching to different address generating mechanisms is carried out with the aid of a control bit.

Published, European Patent Application EP 0 709 767 A discloses a CPU which can execute various instruction-set architectures. In these sets of instructions, the first three bits of an instruction designate the respective set of instructions. In relative addressing and processing of 32-bit instructions, the address space is concealed for 64-bit instructions, so that no problems occur.

The present invention serves for developing a microprocessor which can process different assembler codes. A great difficulty here is that, in the case of different assembler codes, the computation of relative addresses relates to different program counter definitions. For example, the relative addressing in the case of the JAVA byte code always relates to the current assembler instruction, in the case of ECO 2000 Assembler it always relates to the instruction counter reading that is pointing to the next assembler instruction to be executed.

### SUMMARY OF THE INVENTION

It is accordingly an object of the invention to provide a microprocessor and a method of addressing in a microprocessor that overcome the above-mentioned disadvantages of the prior art methods and devices of this general type, in which, dependent on the respective assembler code, a correct relative address computation to the correct relative branch destination or the correct relative data always takes place.

With the foregoing and other objects in view there is provided, in accordance with the invention, a microprocessor for processing various assembler codes. The microprocessor contains a parameter designating a respective assembler code and, depending on how the parameter is set, a different relative addressing takes place. A plurality of program counters are provided and, dependent on the parameter, in each case one of the program counters is active in a computation of relative addresses.

According to the invention, the object is achieved by a microprocessor for processing various assembler codes, in that the parameter that designates the respective assembler code is provided and, dependent on the parameter, a different relative addressing takes place.

According to the invention, it is possible in this case for example to provide a plurality of program counters and, dependent on the parameter, in each case activate one of the program counters for the computation of the relative addresses.

In this case, it is particularly preferred according to the invention that the program counters are connected to a multiplexer, that is controlled by the parameter, and the output of the multiplexer is connected to the computation unit for the relative addresses. In this way, the selection of the correct program counter can take place very easily.

Furthermore, the correct relative addressing can be ensured according to the invention by there being disposed between the program counter and the computation unit for the relative addresses an adding unit. One input of which is connected to the program counter and the other input of which is connected via a multiplexer, which is controlled by the parameter, to a memory for an instruction length or to the value 0, and the output of which is connected to the computation unit.

Similarly, a correct relative addressing can be achieved according to the invention by there being disposed between the program counter and the computation unit for the relative addresses a subtracting unit. One input of the subtracting unit is connected to the program counter and the other input of which is connected via a multiplexer, which is controlled by the parameter, to a memory for the instruction length or to the value 0, and the output of which is connected to the computation unit.

To achieve the object according to the invention, the present invention further teaches a method of relative addressing in a microprocessor in which, dependent on an operating state or parameter for the respective assembler code, relative addresses are differently determined.

For this purpose, it is preferred according to the invention to provide for the various operating states or assembler codes a plurality of program counters, which are selected dependent on the operating state or assembler code.

Similarly, it is preferably possible according to the invention, dependent on the various operating states or assembler codes, to add or subtract the instruction length to or from the program counter reading for the relative address computation, or to leave the program counter reading unchanged.

Similarly, it is possible according to the invention, dependent on the various operating states or assembler codes, to add, or subtract, an instruction length to or from the offset value, which is usually used for the computation of relative addresses, or to leave the offset value unchanged in each case.

In accordance with an added feature of the invention, there is provided a computation unit and a multiplexer connected to the program counters. The multiplexer receives and is controlled by the parameter, the multiplexer has an output connected to the computation unit for the relative addresses.

With the foregoing and other objects in view there is further provided, in accordance with the invention, a microprocessor for processing various assembler codes. The microprocessor contains a multiplexer having a first input, a second input for receiving a 0 value, and a third input receiving a parameter designating a respective assembler code and, depending on how the parameter is set, a different relative addressing takes place. A program counter and a computation unit for computing relative addresses are provided. An adding unit is connected between the program counter and the computation unit. The adding unit has a first input connected to the program counter, a second input connected to the multiplexer, and an output connected to the computation unit. A memory is provided for storing an instruction length and has an output connected to the first input of the multiplexer.

With the foregoing and other objects in view there is further provided, in accordance with the invention, a microprocessor for processing various assembler codes. The microprocessor contains a multiplexer having a first input, a second input for receiving a 0 value, and a third input receiving a parameter designating a respective assembler code and, depending on how the parameter is set, a different relative addressing takes place. A program counter and a computation unit for computing relative addresses are provided. A subtracting unit is connected between the program counter and the computation unit for the relative addresses. The subtracting unit has a first input connected to the program counter, a second input connected to the multiplexer, and an output connected to the computation unit. A memory is provided for storing an instruction length and has an output connected to the first input of the multiplexer.

With the foregoing and other objects in view there is further provided, in accordance with the invention, a method of relative addressing in a microprocessor. The method includes the steps of: determining relative addresses in dependence on one of an operating state and a parameter for a respective assembler code; providing a plurality of program counters for various operating states and assembler codes; and selecting one of the program counters for use in determining the relative addresses in dependence on one of the operating state and the respective assembler code.

Other features which are considered as characteristic for the invention are set forth in the appended claims.

Although the invention is illustrated and described herein as embodied in a microprocessor and a method of addressing in a microprocessor, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a block circuit diagram in which a selection takes place between various instruction counters according to the invention;

FIG. 2 is a block circuit diagram in which, dependent on a respective assembler code, an instruction length is, or is not, added to the instruction counter reading; and

FIG. 3 is a block circuit diagram for computing the instruction counter reading for the relative addressing, in which the instruction length is or is not subtracted from the instruction counter reading.

### DESCRIPTION OF THE PREFERRED EMBODIMENTS

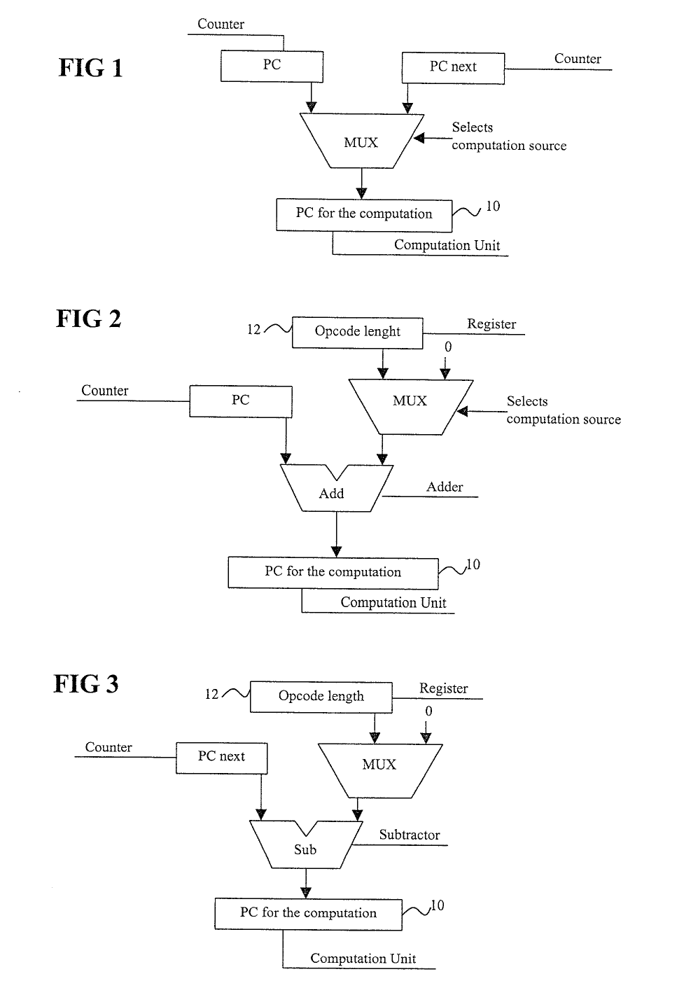

In all the figures of the drawing, sub-features and integral parts that correspond to one another bear the same reference symbol in each case. Referring now to the figures of the drawing in detail and first, particularly, to FIG. 1 thereof, there is shown a first embodiment of the invention in which two instruction counters PC, PCnext are provided in a microprocessor. The instruction counters PC, PCnext in each case contain an instruction counter reading belonging to a corresponding assembler code. One of the counters PC is consequently always pointing to a current program line (for example for JAVA byte code), while a further instruction counter PCnext is always pointing to the program line of a next assembler instruction (for example for ECO 2000 Assembler). The outputs of the two instruction counters PC, PCnext are connected to a multiplexer unit MUX, which, dependent on the assembler code to be processed at the respective time, connects one or the other instruction counter reading through to its output, which is connected to a computation unit 10 for the relative addresses.

FIG. 2 shows a second embodiment of the invention. In this case, only one instruction counter PC, which is always pointing to the current instruction line, is provided. In addition, a register 12, which contains an instruction length (Opcode length), must be provided in the microprocessor. An output of the register 12 is fed here to a multiplexer unit MUX, which is controlled by the parameter that designates the respective assembler code. The other input of the multiplexer MUX is occupied by the value “0”. An output of the multiplexer MUX is fed to an adding unit Add, the other input of the adding unit Add is connected to the instruction counter PC. An output of the adding unit Add is then connected to the computation unit 10 for the relative addresses.

FIG. 3 shows a third embodiment of the invention. In this case, the register 12 that contains the length of an assembler instruction (Opcode length) is likewise provided. Here, too, the output of the register 12 is fed to the multiplexer unit MUX, which is controlled by the parameter that designates the respective assembler code. Here, too, the other input of the multiplexer unit MUX is occupied by the value 0.

By contrast with the embodiment of FIG. 2, here, however, the output of the multiplexer unit MUX is connected to a subtracting unit Sub. The other input of the subtracting unit sub is connected to the instruction counter PCnext. In this case, however, the instruction counter PCnext does not point to the current assembler instruction line, but to the next assembler instruction.

Here, too, the output of the subtracting unit Sub is connected to the computation unit 10 for the relative address computation.

According to a fourth embodiment of the invention, the value of the instruction length may also be added to an offset value which is used for the computation of the relative addresses, or may be subtracted from the offset value.

Since the assembler codes in modern microprocessor systems can be stored at various locations in the main memory before they are processed by the microprocessor, it is required to give addressings in a relative form, that is to say with respect to the respective configuration of the assembler code in the main memory. Relative addressing, in which a specific offset value is additionally computed for all the instructions that are pointing to a different address in the assembler code, serves for this purpose. The offset value usually corresponds to the distance of the assembler code in the main memory, the distance at which the program has been stored away from the operating system. By use of the offset, the relative branch addresses present in the assembler code can then be assigned to the actual physical memory locations of the respective program line.

According to the invention, the adaptation of the relative addressing may then of course also take place in such a way that the Opcode length is added to the offset value, or is subtracted from it.

According to the invention, for example, when using the address of the current instruction line in the instruction counter of the microprocessor, the instruction length can then optionally be added to the offset value if using an assembler that specifies that the instruction counter must point to the next assembler instruction.

Similarly, when managing the address of the next assembler instruction in the instruction counter of the processor, the instruction length can be subtracted from the offset value if an assembler for which the instruction counter must always point to the current assembler instruction is to be processed.

According to the invention, in relative addressing, the reference source, the instruction counter, is influenced in order to select the correct computation specification. In this case it is possible to access both the current instruction counter and the instruction counter which is pointing at the next assembler instruction in order to take into account the different computation specifications. In this case, either the instruction counter PC of the instruction to be processed at the time or the instruction counter PCnext which is pointing at the next instruction is selected, or the respectively associated other values are computed in each case on the basis of one of the instruction counter readings.

Consequently, either both instruction counters PC and PCnext may be logged in two registers, or one of the two instruction counter readings may be computed with the aid of the known instruction length. In this case, either the current instruction counter reading may be used for computing the instruction counter reading pointing at the next instruction PCnext, by adding the instruction length, or the instruction counter reading pointing at the next instruction to be executed can be used for computing the current instruction counter reading PC, by subtracting an instruction length. In addition, in a further variant, the instruction length may be added to the offset value if the address of the current assembler instruction is stored in the instruction counter and the assembler code requires the address of the next instruction to be executed, or the address of the current assembler instruction for the assembler code can be made available by subtraction of the Opcode length from the offset value if the instruction counter of the processor is always pointing at the next assembler instruction to be executed.

According to the invention, it is consequently possible for the first time to realize a processor which allows different assembler programming languages with different computation specifications for relative destinations in relation to the instruction counter within a CPU.

We claim:

1. A microprocessor for processing various assembler codes, comprising:
a parameter designating a respective assembler code and, depending on how the parameter is set, a different relative addressing takes place; and
a plurality of program counters and, dependent on the parameter, in each case one of said program counters is active in a computation of relative addresses.

2. The microprocessor according to claim 1, including:
a computation unit; and
a multiplexer connected to said program counters, said multiplexer receives and is controlled by the parameter, said multiplexer having an output connected to said computation unit for the relative addresses.

3. A microprocessor for processing various assembler codes, comprising:
a multiplexer having a first input, a second input for receiving a 0 value, and a third input receiving a parameter designating a respective assembler code and, depending on how the parameter is set, a different relative addressing takes place;
a program counter;
a computation unit for computing relative addresses;
an adding unit connected between said program counter and said computation unit, said adding unit having a first input connected to said program counter, a second input connected to said multiplexer, and an output connected to said computation unit; and
a memory for storing an instruction length and having an output connected to said first input of said multiplexer.

4. A microprocessor for processing various assembler codes, comprising:
a multiplexer having a first input, a second input for receiving a 0 value, and a third input receiving a parameter designating a respective assembler code and, depending on how the parameter is set, a different relative addressing takes place;
a program counter;
a computation unit for computing relative addresses;
an subtracting unit connected between said program counter and said computation unit for the relative addresses, said subtracting unit having a first input connected to said program counter, a second input connected to said multiplexer, and an output connected to said computation unit; and
a memory for storing an instruction length and having an output connected to said first input of said multiplexer.

5. A method of relative addressing in a microprocessor, which comprises the steps of:
determining relative addresses in dependence on one of an operating state and a parameter for a respective assembler code;
providing a plurality of program counters for various operating states and assembler codes; and
selecting one of the program counters for use in determining the relative addresses in dependence on one of the operating state and the respective assembler code.

6. The method according to claim 5, which comprises performing one of:
performing one of an addition and a subtraction of an instruction length to/from a program counter reading for a relative address computation in dependence on one of the various operating states and the assembler codes; and
leaving the program counter reading unchanged.

7. The method according to claim 6, which comprises performing one of:
performing one of an addition and a subtraction of the instruction length to/from an offset value used for the computation of the relative addresses in dependence on one of the various operating states and the assembler codes; and
leaving the offset value unchanged.
